(19) United States
(12) Patent Application Publication
(10) Pub. No.: US 2006/0210948 A1
(43) Pub. Date: Sep. 21, 2006

(54) Prophylaxis angles and cups

(76) Inventors: Eric P. Rose, Tarzana, CA (US); Andrew B. Ulrich, Stillwater, MN (US); Zoltan Sostarecz, Washington, DC (US)

Correspondence Address: DISCUS DENTAL IMPRESSIONS, INC., 8550 HIGUERA STREET, CULVER CITY, CA, 90232, US

(21) Appl. No.: 11/376,466

(22) Filed: Mar. 14, 2006

Related U.S. Application Data
(60) Provisional application No. 60/662,037, filed on Mar. 14, 2005.

(51) Int. Cl. A61C 3/06; A61C 1/18

(52) U.S. Cl. 433/125; 433/105

(57) ABSTRACT

A prophy angle includes a driven shaft and a driving shaft. The driving shaft as an integrally molded crown gear disposed coaxially thereon. The driven shaft as a carousel gear including a plurality of pins, each pin having a longitudinal axis parallel to a longitudinal axis of the driving shaft. Each pin is coupled to the driving shaft by a fillet. The prophy angle includes a housing that has a major part and a minor part. The driving shaft is inserted into the housing from an open distal end of the major part. The driven shaft is also inserted into the housing at the open distal end of the major part. Thereafter, the minor part of the housing is connected to the major part of the housing to close the open distal end of the major part of the housing.

### CROSS-REFERENCE TO RELATED APPLICATIONS

This application claims the benefit of U.S. provisional patent application, “Prophylaxis Angles and Cups” filed Mar. 14, 2005, Ser. No. 60/662037, the contents of which is hereby incorporated by reference.

### FIELD OF THE INVENTION

This invention relates to dental tools. Specifically, this invention relates to dental or prophylaxis angles and cups used in tooth polishing.

### BACKGROUND OF THE INVENTION

As part of dental hygiene, a patient's tooth is polished by a dental professional during a cleaning visit. Cups are used by dental professionals to carry a polishing paste. The polishing is accomplished by applying a prophylactic polishing paste to the teeth using a small rubber cup, commonly called a prophy cup. The prophy cup is filled or loaded with a prophylactic polishing paste and the filled cup is held against the surface of a tooth while the cup is mechanically rotated. The force of rotation forces the polishing paste to traverse across the surface of the tooth abrading and polishing it.

The cup is attached to a dental angle, called a prophylaxis (prophy) angle. The rotating action is provided by a rotating dental handpiece attached to the prophy angle.

A common problem is the difficulty in retaining the polishing paste within the cup as the cup is rotated against the tooth. The polishing paste is forced out of the cup by centrifical force, and by compression of the prophy cup against the surface of the tooth, and other forces that tend to fling or throw the paste out of the cup, making it necessary to refill the prophy cup many times during a dental prophylactic proceedure. Another common problem is the tendency of some cups to become detached from the prophy angle, either during rotation or during loading of polishing paste.

### SUMMARY OF THE INVENTION

The present invention relates to prophy angles for use in polishing teeth.

In one embodiment of the invention, the angle has a first body having a first axial bore and a second body having a second axial bore, said second body being joined to the first body at an angle to the first body, said axial bores are in communication with each other. The first body may be adapted for attachment to a handpiece and the second may be adapted for rotably housing a shaft part therethrough, said shaft having attached at one end thereto a cup for use in polishing a tooth or teeth.

In one embodiment, the angle may be about 90°. In another embodiment, the angle may be an acute angle. In yet another embodiment, the angle may be an obtuse angle.

In one aspect, the joining portion may have a head portion thereon. In another aspect, the joining portion may have a head and neck portion. In yet another aspect, the head portion may be present on one end of the second body and the neck portion may be present on one end of the first body.

The cup has a distal end that is adapted for holding a polishing material and a proximal end that is adapted for attachment to one end of the shaft part. In one embodiment, the proximal end of the cup has a larger circumferential span than the shaft part and may be over-molded onto one end of the shaft part. In another embodiment, the proximal end of the cup has a smaller circumferential span than the shaft part. In yet another embodiment, the proximal end has the same circumferential span as the shaft part. The portion of the shaft part that is covered by the proximal end of the cup may have various formations adapted for improving the attachment between the pcup and the shaft part.

In one embodiment, the formation may be a horizontal through hole through the side of the shaft part. so that the material of the cup may seep through the hole and serves as an additional anchor to strengthen the attachment forces between the cup and the shaft part. In one aspect, the shaft part may also have a cap over its proximal end.

In another embodiment, the formation in the shaft part may be a vertical through hole extending for a length of the shaft part so that the material of the cup may fill the hole and serves as an additional anchor to strengthen the attachment forces between the cup and the shaft part.

In a further embodiment, the formation may be a combination of a horizontal and a vertical through hole through the side and the top of the shaft part.

In yet another embodiment, the formation may be a combination of horizontal and vertical through holes through the side and the length of the shaft part.

In still yet another embodiment, the formation may have a star-shaped cross-section.

In yet a further embodiment, the cross-section of the formation may be in the shape of a cross.

In still yet a further embodiment, the cross-section of the formation may be in the shape of a square, a rectangle, a hexagon, or a concentric square.

In another further embodiment, the formation may be in the form of a slot.

In another embodiment of the invention, the prophy angle includes a first body having a first axial bore and a second body having a second axial bore, said second boby is joined to the first body at an angle to the first body, said axial bores are in communication with each other. The first body includes a drive gear and the second body includes a driven gear, in a meshing relationship. The driving gear is at one end of the first shaft part which may be adapted for attachment to a handpiece. The second body includes a a second shaft part adapted for rotably rotating a cup thereon for use in polishing a tooth or teeth.

In one embodiment, the driving gear includes a gear part having a surface with integrally formed depressions. The driven gear includes a gear part and a shaft part and is rotatably mounted in the second bore. The driven gear part has a surface with pin-like projections that mate operatively to the depressions of the driving gear.

In one aspect, the driving gear drives the driven gear by means of a Crown and Lantern type gear.

In one embodiment, the crown gear may be disposed within the prophy angle and may include a plurality of gear teeth, each tooth including a pin region having a first substantially cylindrical surface region and a second substantially hemispherical surface region, each tooth of the plurality of gear teeth including a fillet region being disposed between the respective pin region and a central shaft of said crown gear.

In another aspect, the pin-like projections of the driven gear may be bullet-shaped and mesh with the depressions in the gear part of the driving gear.

In one embodiment, one half of the one end portion of the first substantially cylindrical body includes a horse-shoe shaped rib for retaining the driving gear.

In one aspect, a cup may be mounted onto the proximal end of the shaft part of the driven gear.

In another aspect, a cup may be molded onto the proximal end of the cup.

In a further aspect, a cup may be over-molded onto the proximal end of the cup.

The portion of the shaft part that is covered by the proximal end of the cup may have various formations adapted for improving the attachment between the cup and the shaft part, as mentioned before.

The present invention further relates to a prophy angle and cup for use in polishing a tooth or teeth. The prophy angle has a first substantially cylindrical body having a neck portion, with an axial bore joined to, and in communication with, a second axial bore of a second substantially cylindrical body having a head portion. One end of the first substantially cylindrical body including the neck portion and the head portion of the second substantially cylindrical body, form two mating halves which may be welded together after assembly. A driving gear element may be disposed within the first bore and a driven gear element may be disposed within the second bore. The driving gear has a gear part present at one end of a shaft part.

In one embodiment of the invention, the shaft part extends rotatably through the first bore and beyond the distal end of the first substantially cylindrical body, and the gear part extends into the second bore.

In another aspect, the shaft part of the driven gear may include a larger diameter portion with pin-like lateral projections, and a smaller diameter portion with a recess for mounting a cup.

In yet another aspect, the shaft part of the driven gear has four distinct portions having three different diameters. The largest diameter portion has pin-like projections disposed in a substantially concentric circular pattern that is substantially concentric with a longitudinal axis of the smallest diameter portion of the shaft, for mating with the depressions of the driving gear. A cup may be over-molded onto the shaft about the medium diameter portion.

In still yet another aspect, the shaft part of the driven gear has four distinct portions with three different diameters. The largest diameter portion has pin-like projections in a substantially concentric circular pattern around the smallest diameter portion, for mating with the depressions fo the driving gear. A formation may be disposed in the smallest diameter portion on one end of the shaft part, and a cup may be over-molded onto the end of the shaft part.

The portion of the shaft part that is covered by the proximal end of the cup may have various formations adapted for improving the attachment between the cup and the shaft part. The formations may include those mentioned above.

The present invention further relates to a method of manufacturing a prophy angle and cup.

The present invention together with the above and other advantages may best be understood from the following detailed description of the embodiments of the invention illustrated in the drawings, wherein:

### DRAWINGS

FIG. 1 shows, in perspective view, a prophy angle according to one embodiment of the invention;

FIG. 2 shows, in cutaway prospective view, a prophy angle including a gear mechanism according to one embodiment of the invention;

FIG. 3 shows, in ventral view, a prophy angle housing component according to one embodiment of the invention;

FIG. 4 shows a side view of a prophy angle housing component according to one embodiment of the invention;

FIG. 5 shows, in cutaway perspective view, a crown gear and pinion gear mechanism assembly;

FIG. 6 shows, in perspective view, a lantern wheel style mechanism;

FIG. 7 shows, in side view, a driving shaft for a prophy angle according to one embodiment of the invention;

FIG. 8 shows, in perspective view, a portion of a driving shaft for a prophy angle, including a driving gear, according to one embodiment of the invention;

FIG. 9 shows, in perspective view, a portion of a gear mechanism assembly for a prophy angle according to one embodiment of the invention;

FIG. 10 shows, in perspective cutaway view, a portion of a driven gear for a prophy angle according to one embodiment of the invention;

FIG. 11 shows, in cross section, a driven shaft and prophy cup for a prophy angle according to one embodiment of the invention;

FIGS. 12A-12L show, in perspective view, prophy cup coupling features for a prophy angle driven shaft according to various embodiments of the invention;

FIG. 13 shows, in flow diagram form, a portion of a manufacturing process for a prophy angle according to one embodiment of the invention;

FIG. 14 shows a perspective view of one embodiment of the prophy cup according to one embodiment of the invention;

FIG. 14a shows the front view of the embodiment of FIG. 14;

FIG. 15a a side view of one embodiment of the prophy cup according to one embodiment of the invention;

FIG. 15b shows the front view of the embodiment of FIG. 15a;

FIG. 15c shows a front view of another embodiment of FIG. 15a;

FIG. 16a shows a perspective view of one embodiment of the prophy cup according to one embodiment of the invention;

FIG. 16b shows the front view of the embodiment of FIG. 16a; and

FIG. 16c shows a cut-away view of the prophy cup of FIG. 16a, showing also the coupling feature.

### DETAILED DESCRIPTION OF THE INVENTION

The detailed description set forth below is intended as a description of the presently exemplified invention provided in accordance with aspects of the present invention and is not intended to represent the only forms in which the present invention may be prepared or utilized. The description sets forth the features and the components of the invention and related systems of the present invention and it is to be understood, however, that the same or equivalent functions and components included in the description may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

Prophy angles carry dental bits such as prophy cups and brushes. The angle of the prophy angle enables dentists to more easily reach the various surfaces of a patient's teeth so as to facilitate the cleaning of the teeth. A prophy angle generally includes a housing with a head and neck portion.

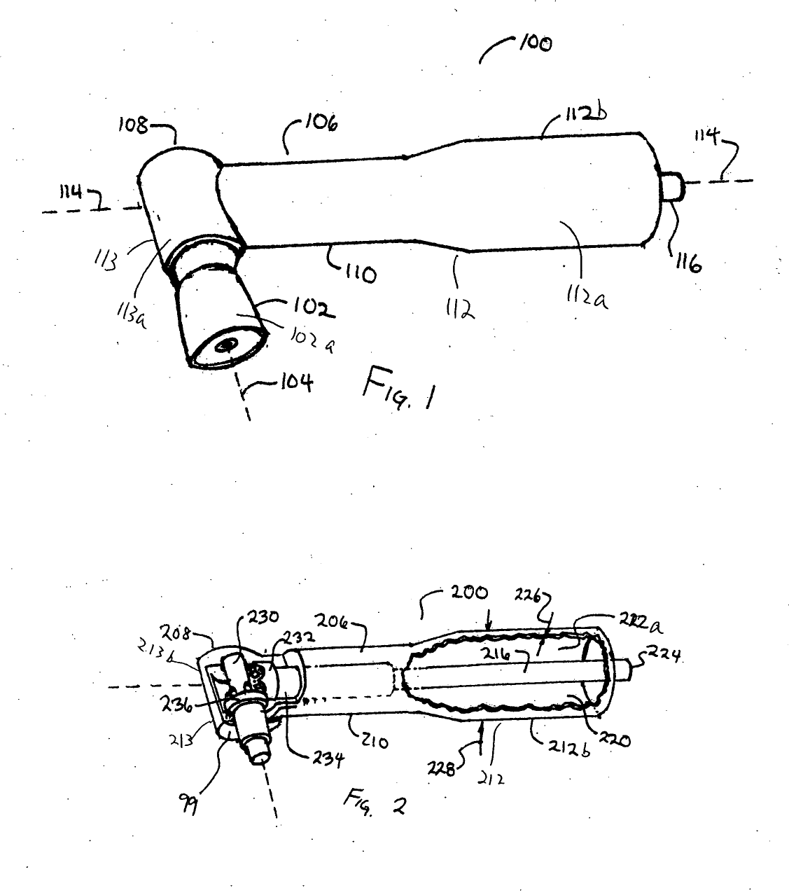

Typically, the angle 100 has a first body 112 having a first axial bore 112a and a second body 113 having a second axial bore 113a, said second boby 113 being joined to the first body 112 at an angle to the first body 112, said axial bores 112a and 113a are in communication with each other as exemplified in FIG. 1.

FIG. 1 shows, in perspective view, a prophy angle 100 according to one embodiment of the invention. The first body 112 may be adapted for attachment to a handpiece (not shown) and the second 113 is adapted for rotably housing a shaft part 230 therethrough, said shaft part 230 having attached at one end thereto a cup 102 for use in polishing a tooth or teeth.

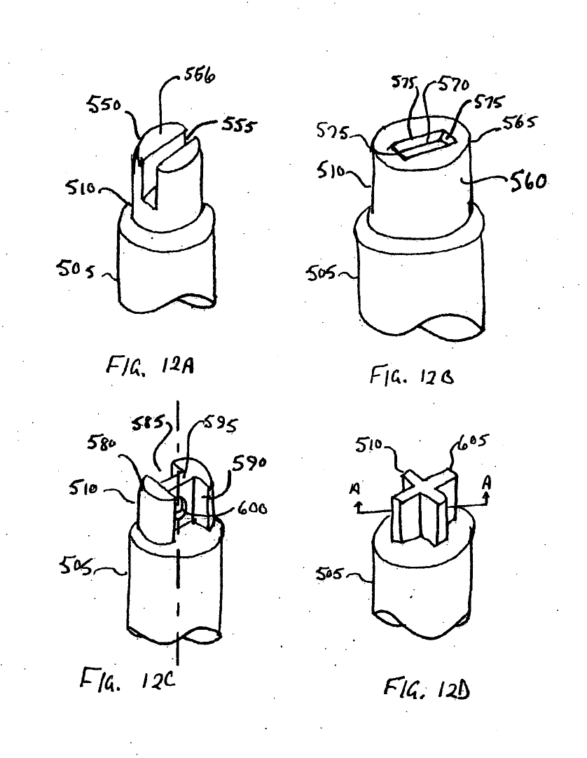

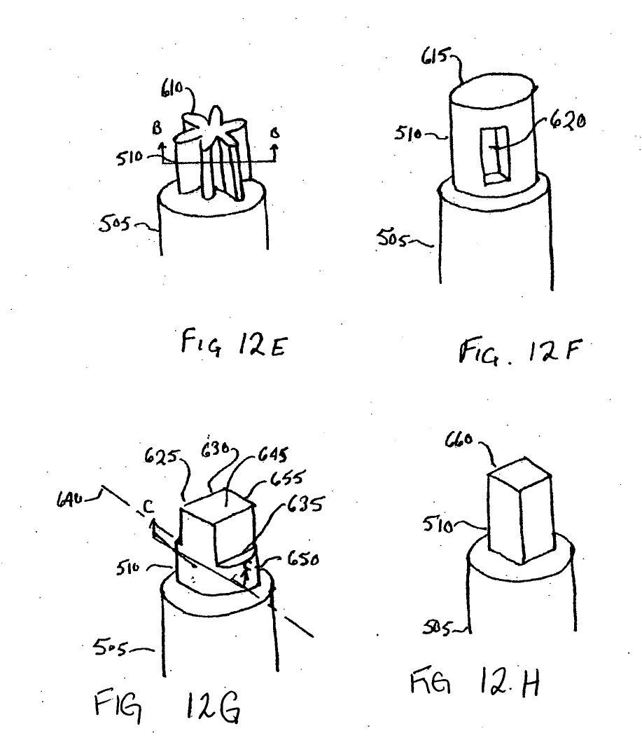

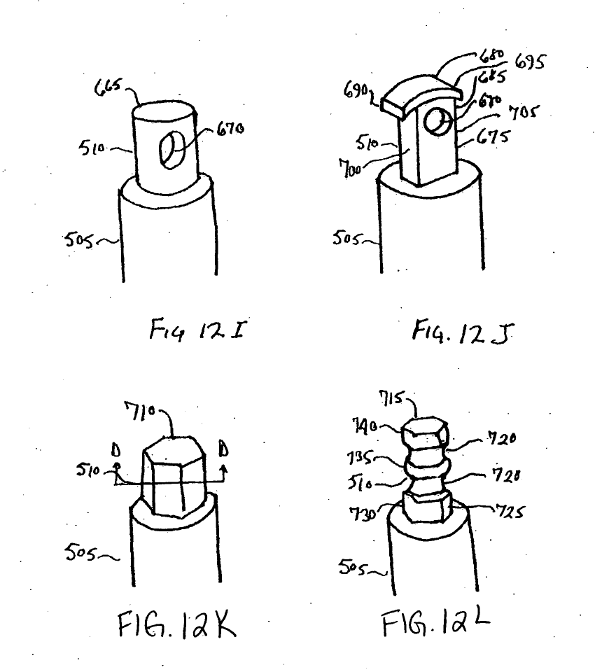

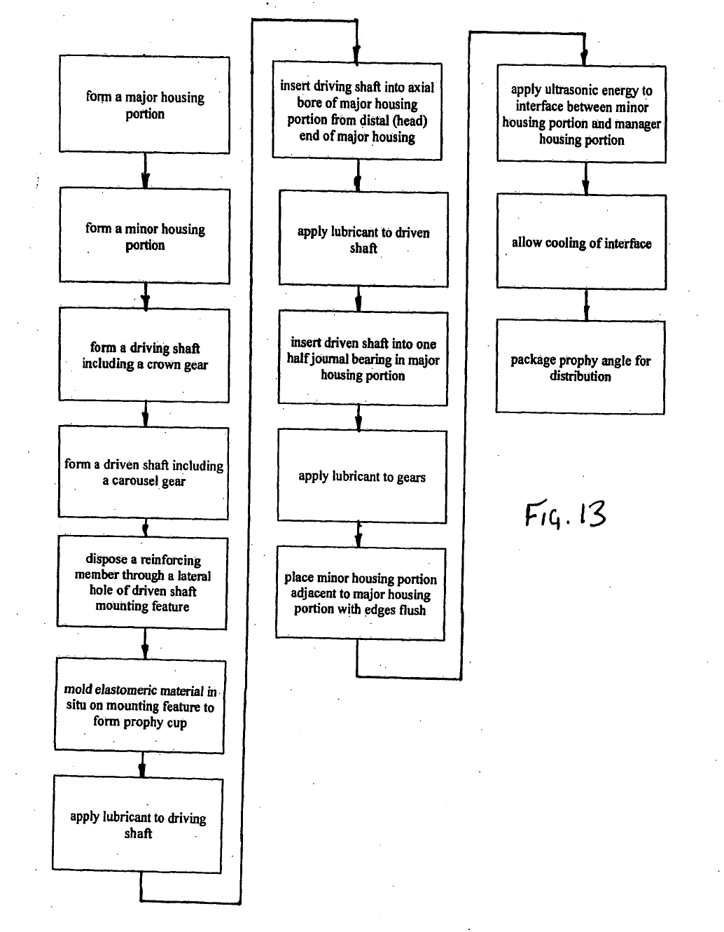

The cup 102, has a housing 102a formed of a resilient material such an elastomeric polymer. The cup 102 may be substantially rotationally symmetrical about a first longitudinal axis 104 and be coupled to the shaft part 230, which may be part of a drive mechanism. The cup 102 may be attached to the driven shaft part 230 in a variety of attachment methods, including, for example, a snap-on attachment, a co-molded attachment, or an over-molded attachment method. The shaft part 230 may also include some formations or coupling features 510, some embodiments of which are exemplified in FIGS. 12 A-L and which will be dscribed in more detail below.

The drive mechanism may include a drive gear 232 and a driven gear 236. In one aspect, the drive gear 232 may be present inside the first axial bore 112a and the driven gear 236 may be present inside the second axial bore 113a, and thus the drive mechanism may be contained within the angle. In another aspect, the drive gear may be part of the haeadpiece (not shown).

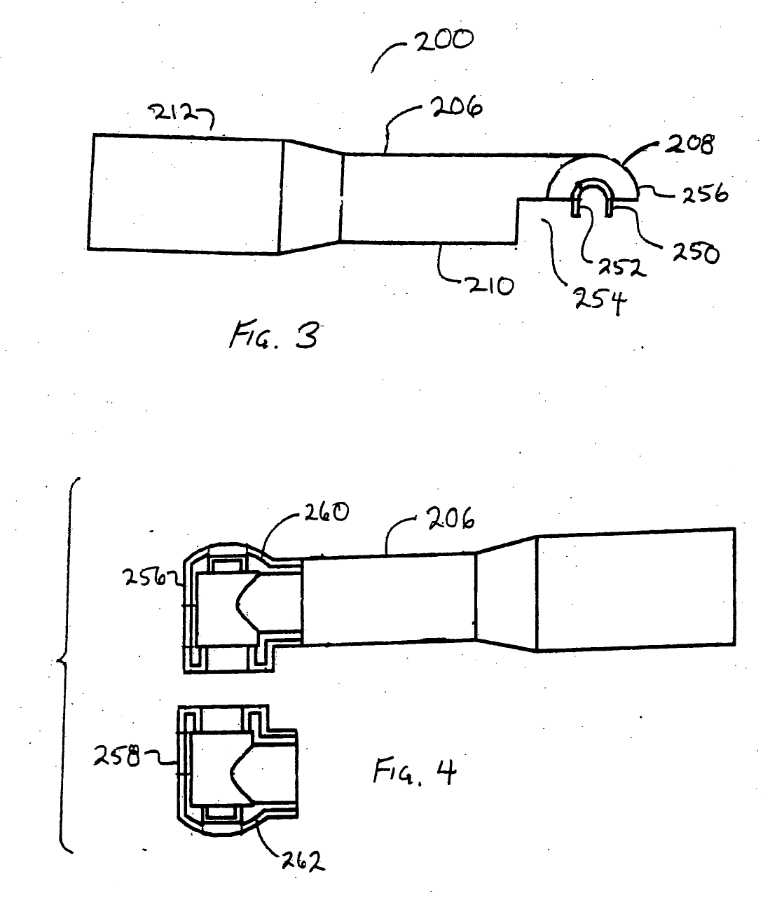

According to one embodiment of the invention, the prophy angle 100 may be a disposable prophy angle, and the housing 106 may be formed of a polymeric material. The housing 106 of the first body 112 includes a neck portion 110, and a skirt portion 112b. The second body 113 may include a head portion 108 at its distal end. In one aspect, the first body 112 and the second body 113 may be integrally formed. In another aspect, the first body 112 and a portion of the second body 113 may be integrally formed while the remainder of the second body 113 may be separately formed and then joined to the neck portion 110 and the rest of the second body 113 during assembly of the prophy angle, as exemplified in FIGS. 3 and 4 below. In one embodiment, the neck portion 110 and skirt portion 112b may exhibit a rotational symmetry about a second longitudinal axis 114. As noted, in some embodiments, the driving shaft 116 may be disposed within the neck 110 and skirt 112b portions of the housing 106. According to another embodiment, the driving shaft 116 may be part of the headpiece. In all aspects, the driving shaft 116 has a longitudinal axis that may be disposed substantially coincident with longitudinal axis 114 of the neck 110 and skirt 112b portions.

FIG. 2 shows, in cutaway perspective view, a portion of a prophy angle 200 according to one embodiment of the invention. As exemplified, the prophy angle 200 includes a first body 212 having a housing 206 with a neck portion 210 and a skirt portion 212b. The skirt portion 212b includes an inwardly facing surface 220 defining an internal cavity or first axial bore 212a within the housing 206 of the prophy angle 200. In one embodiment, this internal cavity 212a is exemplified to be adapted to receive the driving shaft 216. Also, within the skirt portion 212b, a portion of the cavity 212a may also be adapted to receive a portion of a housing of a handpiece (not shown). The handpiece includes a drive motor such as an air motor. In some embodiments, the handpiece may include the driving shaft 216.

The handpiece may also include a formation or coupling feature (such as a mechanical chuck), which may be adapted to be coupled to the driving shaft 216 near a proximal end whereby rotational energy is received at the driving shaft 216 from the air, fluid or electrical motor by way of the coupling feature. In one aspect, a wall thickness 226 of skirt portion 212b is desirably thin so that an overall diameter 228 of skirt portion 212b is small (i.e. not much larger) as compared with an outer diameter of the hand piece housing.

According to one embodiment of the invention, the head portion 208 of the second body 213 may include a driven shaft 230. The driven shaft 230 is supported on bearing surfaces within the head portion 208 of the second body 213. In one embodiment, the driving gear 234 may include a gear part 232 having a surface with integrally formed depressions. The driven gear or shaft part 230 may include a gear part 236 and is rotatably mounted in the second bore 113a. The driven gear part 236 may have a surface with pin-like projections that mate operatively to the depressions of the driving gear 216.

In one aspect, the driving mechanism includes a Crown and Lantern type gear. The driving gear is a crown gear 232 at a distal end 234 thereof, and the driven shaft 230 includes a carousel gear 236 disposed coaxially with respect to the driven shaft 230, as exemplified in FIG. 2. As shown in FIG. 2, the crown gear 232 and carousel gear 236 are configured to mesh with one another so as to effectively transfer rotational energy from the driving shaft 216 to the driven shaft 230 while changing the orientation of the axis of rotation from a first direction along longitudinal axis 147 to a second direction along axis longitudinal axis 104.

In another aspect, the pin-like projections of the driven gear 236 may be bullet-shaped and mesh with the depressions in the gear part 232 of the driving gear shaft 216.

FIG. 3 shows a ventral view of a prophy angle 200, according to one embodiment of the invention. As discussed in relation to the previously illustrated embodiments, the housing 206 may include a neck portion 210 and a skirt portion 212b. As illustrated, the second body 213 includes a head portion 208 which includes a U-shaped member 250. The U-shaped member 250 has an internal bearing surface 252 that is adapted to support a corresponding outer surface of driven shaft 230 (as shown in FIG. 2).

Also, as shown in FIG. 3, the housing 206 includes a cut-out region 254, such that only a first part 256 of the head portion 208 is integrally formed with the balance of the housing 206. A second part 258 (as shown in FIG. 4) of the head portion 208 is separately formed and adapted to be coupled to the first part of the head portion, and the balance of the housing 206, during an assembly operation of the prophy angle 200.

FIG. 4 shows a side view of the prophy angle housing 206 illustrated in FIG. 3. As seen in FIG. 4, the first part 256 of head portion 208 of the housing 206 includes a housing wall with a coupling surface 260. The coupling surface 260 may be adapted to be disposed adjacent to a corresponding coupling surface 262 of the second (cap) part 258 of head portion 206.

According to one embodiment, coupling surfaces 260 and 262 are substantially flat. In another embodiment, coupling surfaces 260 and 262 are not flat, but may have complimentary or similar formations or surface features. For example, in one embodiment, coupling surface 260 may be convex and coupling surface 262 may be concave. In another embodiment, coupling surfaces 260 and 262 are not flat but have similar surface attributes. For example, according to one embodiment, coupling surfaces 260 and 262 may both be convex

According to one embodiment, surfaces 260 and 262 may be bonded to one another during manufacturing of the prophy angle by an ultrasonic welding technique. In one embodiment, the surfaces 260 and 262 may include a shadow groove. In another embodiment of the invention, surfaces 260 and 262 may be bonded to one another during manufacturing by application of a topical adhesive, for example, a heat sealing adhesive, or a one-part or a two-part structural adhesive. In still another embodiment of the invention, surfaces 260 and 262 may be bonded to one another during manufacturing by chemical welding, and in yet another embodiment, surfaces 260 and 262 may be bonded to one another during manufacturing by a thermal welding process.

FIG. 5 exemplifies, in cutaway perspective view, a gearing arrangement 280 of one embodiment of the invention, including a crown gear 282 and a pinion 284. The crown gear 282 is a contrate gear; i.e., a gear having teeth at right angles to a plane of rotation of the gear. The crown gear 282 may be adapted to rotate about an axis 286 that is perpendicular to the plane of rotation of the crown gear 282.

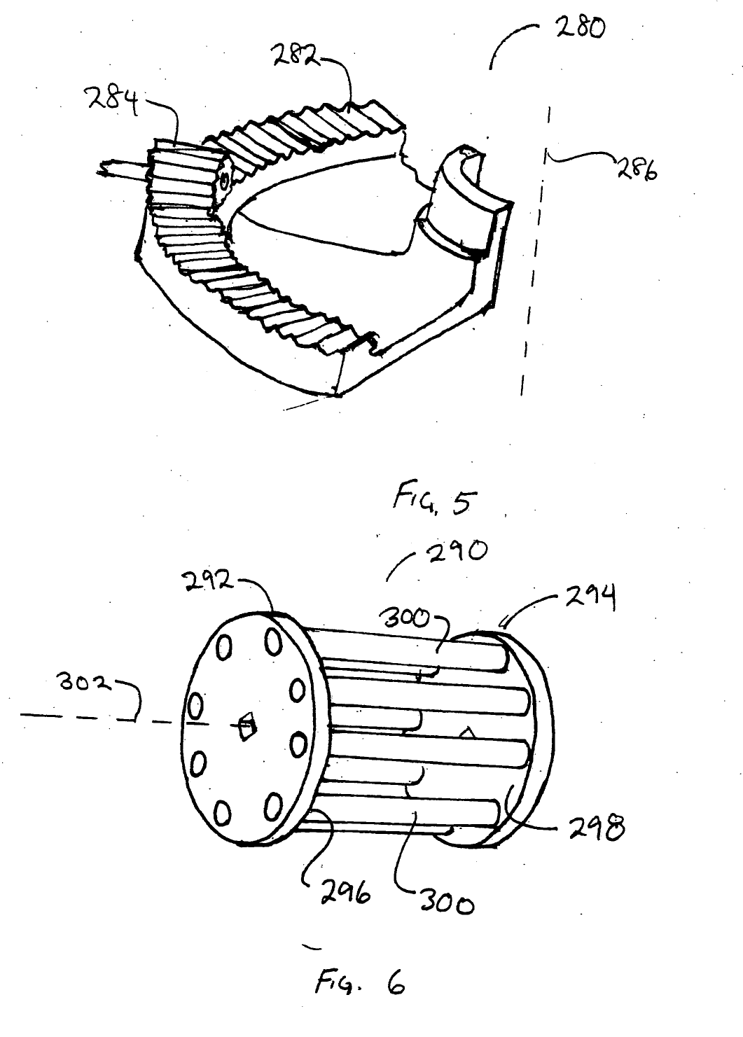

FIG. 6 shows, in perspective view, a lantern wheel (gear) 290. Lantern wheel 290 includes a first disk 292 and second disk 294. The disks 292 and 294 have respective inner surfaces 296 and 298 disposed in substantially parallel spaced relation to one another. Disposed between surfaces 296 and 298 are a plurality of dowels or rods 300. The rods 300 are coupled at respective first and second ends thereof to surfaces 296 and 298. Each rod 300 has a respective longitudinal axis that is disposed substantially perpendicularly with respect to both surfaces 296 and 298. The lantern wheel 290 is adapted to rotate about an axis 302 that is also perpendicular to surfaces 296 and 298.

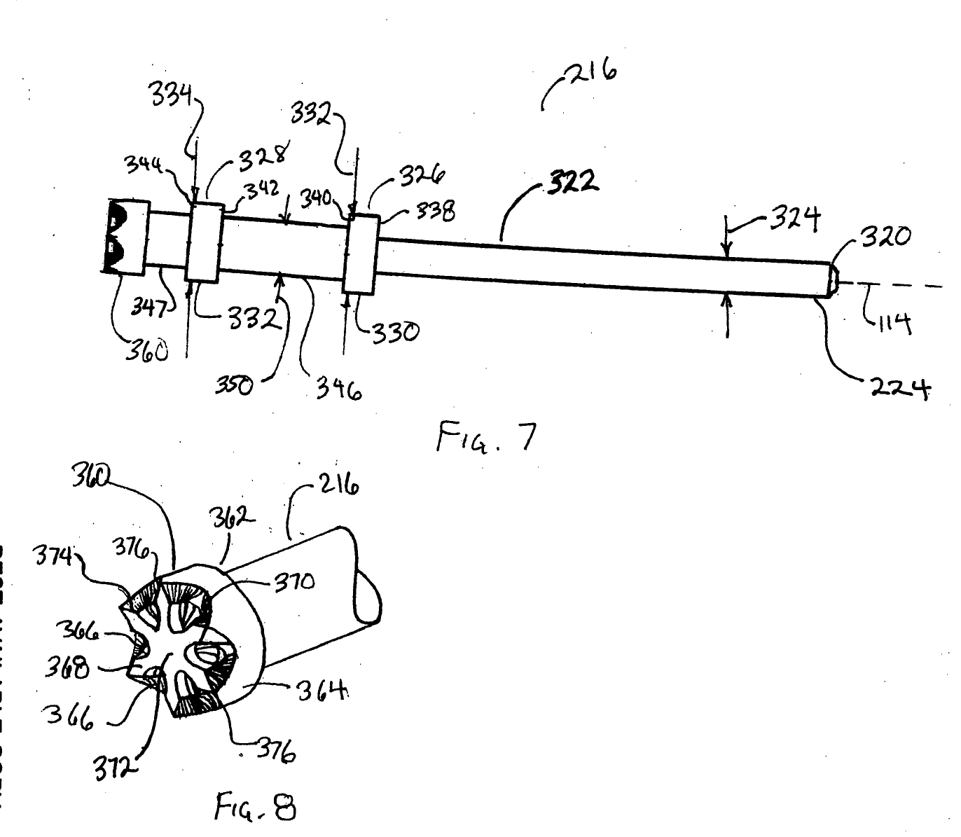

FIG. 7 shows a side view of a driving shaft 216 according to one embodiment of the invention. The driving shaft 216 includes a proximal end 224, adapted to be received into a coupling feature of a motorized handpiece. In the illustrated embodiment, a circumferential edge 320 of proximal end 224 is chamfered. This chamfered edge 320 improves the handling and appearance characteristics of the shaft 216 and facilitates insertion of the shaft end 224 into the coupling feature of the motorized handpiece. The driving and driven gear mechanism described here is amenable to a prophy angle 200 having a self-contained drive mechanism. Other drive mechanisms may be amenable to either a self-contained drive mechanism or drive mechanisms where the driving shaft 216 may also be part of the handpiece.

Driven shaft 230 may include a first region 322 having a first substantially uniform diameter 324 that is substantially uniform along longitudinal axis 114 of the shaft. The shaft 230 includes first 326 and second 328 collar regions. Each collar region has a respective circumferential surface 330, 332. The circumferential surfaces 330 and 332 are disposed at respective diameters 332 and 334 that are, according to one embodiment, larger than the diameter 324 of the first shaft region 322. In one aspect, diameter 332 may be substantially equal to diameter 334. In another aspect, diameter 332 may be larger than diameter 334. In still another aspect, diameter 332 may be smaller than diameter 334.

The collar regions 336 and 328 each include respective proximal and distal radial surfaces. Thus, collar region 326 has radial surfaces 338 and 340 and collar region 328 has radial surfaces 342 and 344.

A shaft region 346 may be, for example, disposed between collar regions 326 and 328 and, more for example, between distal radial surface 340 and proximal radial surface 342.

In the FIG. 7 embodiment, shaft region 346 includes a circumferential surface with a diameter 350 that is substantially uniform along longitudinal axis 114 and that has a diameter intermediate between diameter 332 of collar region 326 and diameter 324 of shaft region 322. In another embodiment of the invention, diameter 350 may be substantially equal to diameter 324.

In other embodiments, shaft region 346 may include a circumferential surface having various features. For example, according to one embodiment, shaft region 346 may include a circumferential surface that varies periodically along longitudinal axis 114. In another exemplary embodiment, shaft region 346 may include a circumferential surface that varies monotonically along longitudinal axis 114. In still another exemplary embodiment, shaft region 346 may include a circumferential surface that includes a helical projecting feature. In still yet another exemplary embodiment, the shaft region 346 may include a plurality of elevations and depressions. Shaft 216 may include a further shaft region 347 disposed between the distal radial surface 344 of collar region 328 and gear 360. In the illustrated embodiment, the gear 360 is a crown gear, as noted before, while other gears are contemplated. In the exemplified embodient, crown gear 360 is disposed at the distal end of shaft 224, and is substantially coaxial therewith.

FIG. 8 shows, in perspective view and in additional detail, crown gear 360 coupled to distal end of shaft 224. According to one embodiment of the invention, crown gear 360 may be formed as an integral member with shaft 216. In another embodiment, crown gear 360 may be formed separately from shaft 216 and coupled thereto by, for example, welding, adhesive fastening, or the use of a mechanical fastener or any other coupling method mentioned above.

In the illustrated embodiment, gear 360 includes a body member 362 having a substantially cylindrical outer surface 364. The body member 362 may have a rear surface with a substantially circular perimeter, and is disposed substantially perpendicular to the longitudinal axis of the driving shaft 216. The body member 362 may have a front surface having a plurality of recessed surface regions 366, defining respective cavities between teeth 368 of the gear 360. In one embodiment, the recessed surface regions 366 adjoin circumferential surface 364 to form an epicycloidal edge 370. In another embodiment, the recessed region 366 may include a surface having a substantially spherically concave portion.

The plurality of recessed regions may be disposed substantially equi-angularly with respect to the driving shaft 216, and each recessed region of the plurality of recessed regions 366 may be adapted to receive a pin of a carousel gear 236.

In the presently illustrated embodiment, distal surface 372 of gear 360 includes a substantially stellate edge 374, including a plurality of substantially pointed edge vertices 376.

FIG. 9 shows, in perspective view, a gear 360, similar to that of FIG. 8, in conjunction with a carousel gear 236 similar to that previously shown in FIG. 2. According to the illustrated embodiment, the carousel gear 236 is substantially fixedly coupled in coaxial relation to driven shaft 230. As exemplified, carousel gear 236 includes a disk portion 380 having a circumferential surface 382, a proximal radial surface 384 and a distal radial surface 386. The proximal radial surface 384 adjoins the circumferential surface 382 at a substantially circular edge 385. The disk portion 380 is supported on, and disposed substantially coaxially with, driven shaft 230, which is coupled to radial surfaces 384 and 386.

According to one embodiment of the invention, the carousel gear 236 may be integrally formed with driven shaft 230. In another embodiment, the carousel gear 236 and driven shaft 230 may be formed in discrete process steps and thereafter integrated to form a substantially fixedly coupled assembly. In still another embodiment, one or the other of the carousel gear 236 and the driven shaft 230 may be formed, and thereafter, the other of the carousel gear 236 and the driven shaft 230 may be formed in situ in substantially fixed relation to the first formed component. In one embodiment of the invention, a diameter 387 of the driven shaft 230 on one side of the carousel gear 236 may be different from a diameter 388 of the driven shaft 230 on the other side of the carousel gear 236. According to one embodiment, the diameter 388 on the distal side of the carousel gear 236 may be larger than the diameter 387 on the proximal side of the carousel gear 236.

As shown in the embodiment of FIG. 9, the carousel gear 236 includes a plurality of pin members 390 coupled to proximal surface 384.

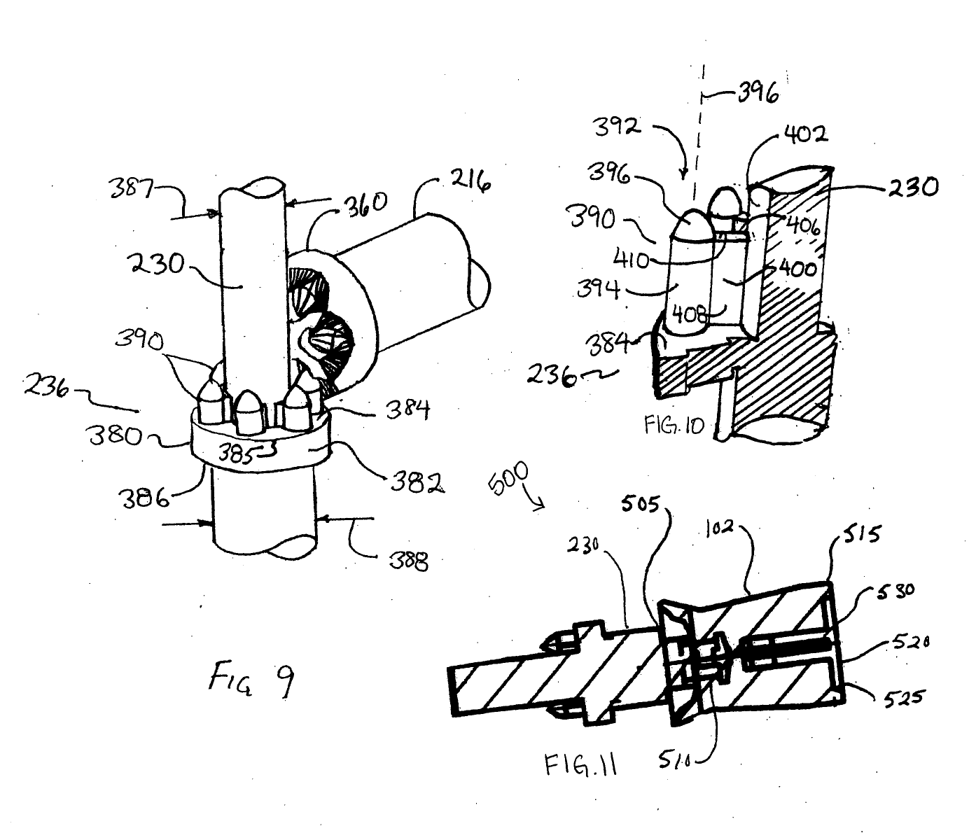

FIG. 10 shows, in perspective cutaway view, a portion of a carousel gear 236 according to one embodiment of the invention. In one embodiment, each pin member 390 of the plurality of pin members includes a pin body 392 having a substantially cylindrical circumferential surface 394 disposed about a longitudinal axis 396 of the pin body.

In one embodiment, a proximal end (top) surface 396 of the pin 390 may include a convex hemispherical surface portion. In another embodiment, the proximal end surface 396 of pin 390 may include an ellipsoid surface portion. In a further embodiment, the proximal end surface 396 of pin 390 may include an ovoid surface portion. In yet another embodiment, the proximal end surface 396 of pin 390 may include a conical surface portion. In still another embodiment, the proximal end surface 396 of pin 390 may include a truncated conical surface portion. In yet still another embodiment, the proximal end surface 396 of pin 390 may include a terraced surface portion. In a still further embodiment, the proximal end surface 396 of pin 390 may include a concave surface portion and, in various other embodiments, the end surface 396 may include, for example, two or more of the foregoing features in combination.

In a further embodiment of the invention, a respective fillet member 400 may be disposed radially between a circumferential surface 402 of the driven shaft 230 and the respective circumferential surface 394 of each pin member 390. According to one embodiment, the fillet member 400 may include first 406 and second 408 radial side surfaces and a radial top surface 410. According to another embodiment, first 406 and second 408 radial side surfaces may adjoin proximal radial surface 384. In yet another embodiment, one or both of respective side surfaces 406 and 408 may be disposed substantially perpendicular to proximal radial surface 384. In still another embodiment, one or both of respective side surfaces 406 and 408 may be disposed at a respective oblique angle with respect to proximal radial surface 384.

In one embodiment of the invention, radial side surfaces 406 and 408 each may include a respective perimeter that is substantially rectangular. In another embodiment of the invention, radial side surfaces 406 and 408 may each be substantially flat. In yet another embodiment of the invention, radial side surfaces 406 and 408 may each be substantially monotonically concave. In still another embodiment of the invention, radial side surfaces 406 and 408 may each be substantially monotonically convex. In still yet another embodiment of the invention, radial side surfaces 406 and 408 may include a surface texture. In a further embodiment of the invention, radial side surfaces 406 and 408 may each include an aperture of particular or arbitrary configuration therein such that a respective through-hole may be configured through each fillet member 400 of the plurality of fillet members.

FIG. 11 shows a cross-sectional view of a driven assembly 500. The driven assembly has a driven shaft 230 as described above with regard to FIG. 2. A portion 505 is located substantially co-axially on the driven shaft 230. The portion 505 supports a coupling feature 510. In one embodiment of the invention, the driven shaft 230, portion 505 and coupling feature 510 may be molded as a single piece. In alternative embodiments, the driven shaft 230, portion 505 and coupling feature may be welded to form a substantially integrated assembly. The driven shaft 230, portion 505 and coupling feature 510 may be, for example, made of a plastic material.

In one aspect of the invention, a prophy cup 102 is provided at a distal end of the driven shaft 230. According to various embodiment of the invention, the prophy cup 102 may be configured to provide effective retention and distribution of a prophy paste for polishing of a tooth surface, to be discussed below. According to one embodiment of the invention, the prophy cup 102 may be formed of an elastomeric polymer, and may be adapted to flex so that the elasticity of the prophy cup 102 may apply an even and effective pressure to effect desirable abrasive polishing of the tooth surface by urging an abrasive component of the prophy paste towards the tooth surface.

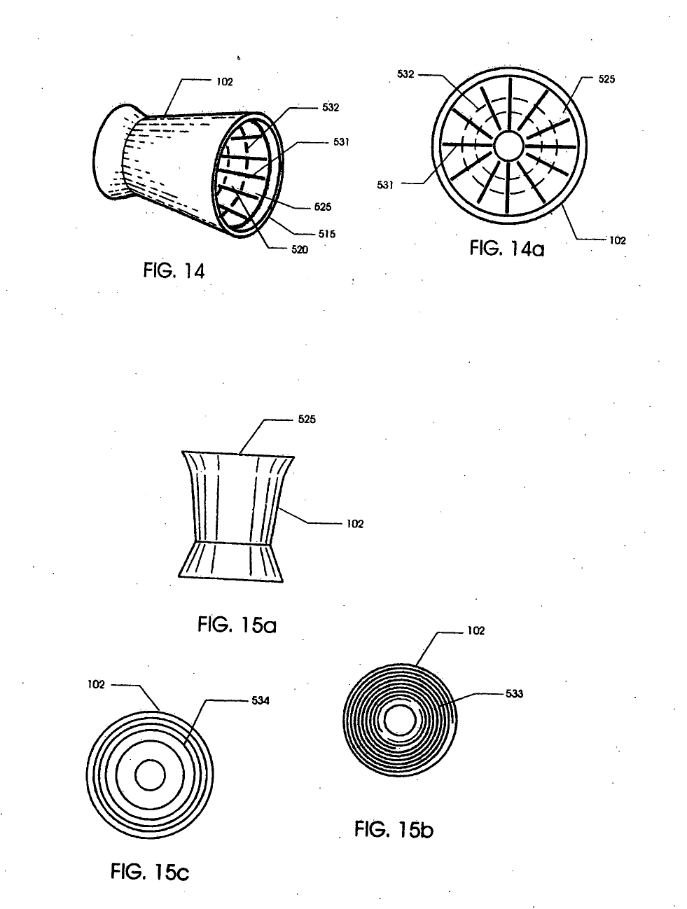

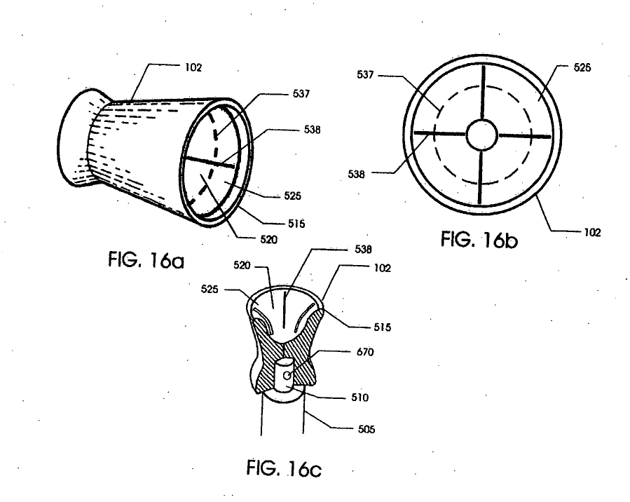

The illustrated prophy cup 102 in FIG. 11 is partially hollow at a distal end 515 where a circumferential inner surface 525 defines a cup portion 520. According to one embodiment, the circumferential inner surface 525 may be axially striated (as exemplified in FIGS. 14, 14a, 16, 16a and 16b), or radially striated (as shown in FIGS, 15, 15a and 15b) as striations 531, 538, 533, 534 or combinations thereof. The combinations are shown in FIGS. 14, 14a, 16a, 16b and 16c in solid and dotted lines.

In one aspect, the striations 531 may be depressions or valleys formed on the inner surface 525 of the cup 102. In another aspect, the striations 531 may be fins or ribs formed on the inner surface 525 of the cup 102. In a further aspect, the striations 531 may be a combination of depressions or valleys and ribs or fins. In one embodiment, the striations 531 may be extended towards and close to the distal end 515 of the cup 102. In another embodiment, the striations531 may benot be extended close to the distal end 515 of the cup 102.

According to one embodiment, a plurality of depressions or valleys, or fins or ribs 531, 538, 533 or 534 may be uniformly dimensioned along its length or width. According to another embodiment, a plurality of depressions or valleys, or fins or ribs 531, 538, 533 or 534 may be non-uniformly dimensioned along its length or width. In one aspect, 531 or 538 may be thicker or broader towards the outer portion of the cup 102 than towards the inner portion. In another aspect, 531 or 538 may be thiner or narrower towards the outer portion of the cup 102 than towards the inner portion. In a further aspect, the dimension of 531 or 538 may be random along its length.

According to another embodiment, a plurality of fins or ribs, or depressions or valleys 533 or 534, as exemplified in FIG. 15c, may extend radially inward from the inner wall 525 in substantially concentric circles. According to another embodiment, a plurality of fins or ribs, or depressions or valleys 533 or 534, as exemplified in FIG. 15b, may extend radially inward from the inner wall 525 in substantisally helical fashion.

In other embodiments, the stratitions for example, striations 531, 538, 533, 534 discussed above may be random and may be made by roughening the inner wall of the cup 102 in the form of pits and bumps. In still other embodiments, the prophy cup 102 may include a substantially circular cylindrical outer surface. In yet still other embodiments, the prophy cup 102 may include a substantially conical outer surface region. In still some embodiments, a distal end of the prophy cup 102 may include a recessed radial surface region. In one aspect, the recessed radial surface region may include a plurality of axial columns supported thereon. In another aspect, a plurality of axially aligned bristles may be formed, for example, of nylon, natural bristle, or other appropriate material, and may be disposed within a cavity of the prophy cup 102 defined by the recessed surface region. Yet another aspect may include an inwardly facing circumferential wall adjoining the recessed radial surface region of a prophy cup 102. In yet a further aspect, a plurality of coaxially aligned circumferential tubes may be distributed within a recessed region. In still another aspect, a plurality of flexible members having a “turbine blade” configuration may be disposed within the recessed region. The turbine blade members may be adapted to move the prophy paste in a desirable direction during operation of the prophy angle 102.

Any of these random striations or striations 531, 538, 533, 534 or combinations thereof, pits and bumps, or any of the cup designs may help to facilitate in retaining the, for example, prophy paste, polishing paste or gel and/or to minimize splattering during use within the cup 102 as the cup 102 is rotated against the tooth by counteracting the centrifical force that is forcing the polishing paste out of the cup 102, and/or the compression of the prophy cup 102 against the surface of the tooth, and/or other forces that may tend to fling or throw the paste out of the cup, making it necessary to refill the prophy cup many times during a dental prophylactic procedure.

As noted above, the driving gear 232 may be part of the prophy angle or may be part of the handpiece. When present as part of the prophy angle, for example, a one-piece drive gear including a gear part 232 and a shaft part 216, as exemplified in FIG. 2 discussed above, the shaft part 216 extending rotatably through said first bore 212a, with the gear part 232 extending into the second bore 213a. A driven gear 236 and shaft part 230 may be rotatably mounted in the head bore 208 and operatively connected to the drive gear 232, and the driven shaft part 230 including means for retaining and mounting a cup 102.

In one embodiment of the invention, the configuration of the driven shaft 230, the bearings within the head of the prophy angle housing 206, and the prophy cup 102, may be adapted to urge the prophy cup into “hula” motion during operation of the prophy angle 100. During operation of the prophy angle 100, the prophy cup 102 may rotate around a longitudinal axis of the driven shaft 230. At the same time, a longitudinal axis of the driven shaft 230 may exhibit a cyclical and/or stochastic motion. The result of this cyclical and/or stochastic motion is that the distal end of the driven shaft 230 moves with respect to the head 108 of the prophy angle housing 206. In one embodiment of the invention, the motion of the distal end of the driven shaft 230 may conform to a substantially circular path. In another embodiment of the invention, the distal end of the driven shaft 230 may conform to a substantially “figure-8” path. In still another embodiment of the invention, the distal end of the driven shaft 230 may follow a “random walk” within constraints imposed by the bearings of the prophy angle housing 206. According to another embodiment of the invention, the distal end of the driven shaft 230 may move diametrically across the head 208 of the prophy angle housing 206. According to in yet another embodiment of the invention, this diametrical motion may follow an angular progression. These “hula” motions may be employed alone or in combination. These “hula” motion may also improve the effectiveness of the polishing action as well as the paste retention.

According to one embodiment of the invention, the prophy cup 102 may be made of any elastomeric material and may be molded in situ onto the coupling feature 510 such that the prophy cup 102 is substantially non-removably fixedly coupled to the coupling feature 510. In one aspect, the co-molding may result in the proximal end of the cup 102 being of the same circumferential span as the coupling feature 510 of the shaft part 230. In a further aspect, the co-molding may result in the proximal end of the cup 102 having a larger circumferential span than the shaft part 230 and may be over-molded onto one end of the shaft part 230.

According to another embodiment of the invention, the prophy cup 102 may be made of any elastomeric material and may be over-molded in situ onto the coupling feature 510 such that the prophy cup 102 is substantially non-removably fixedly coupled to the coupling feature 510. In one aspect, the over-molding may result in the proximal end of the cup 102 having a larger circumferential span than the coupling feature 510 of the shaft part 230.

In any embodiment described above, the portion of the shaft part 230 that is covered by the proximal end of the cup 102 includes the coupling features 510, as noted above. The coupling feature 510 may have various formations adapted for improving the attachment between the cup 102 and the shaft part 230, some of which are as exemplified in FIGS. 12A-12L.

The embodiments exemplified in FIGS. 12A-12L, show perspective views of the various alternative embodiments of the coupling feature 510, for improving the attachment strength of the cup to the shaft part 230.

FIG. 12A is a perspective view of a first examplary embodiment of the coupling feature 510 where the coupling feature 510 is substantially a cylinder 550 positioned substantially coaxially with the the cup 102 when mounted or attached to the shaft part 230. The shaft part may have two portions 510 and 505 having different circumferential span or diameters. The cylinder 550 may have a diametric notch 555 extending partially inward from a distal surface 556 of the coupling feature 510 toward the portion 505. In this embodiment, the formation or coupling feature may be in the shape of a slot when view from the end of the shaft part 230.

The material used for forming the cup 102 may fill in the slot formation and improve the anchoring strength between the cup 102 and the shaft part 230, in the embodiments where the cup 102 is over-molded or the embodiments where the cup 102 is not over-molded onto the shaft part 230.

FIG. 12B shows, in perspective view, a second examplary embodiment of the coupling feature 510. The coupling feature 510 includes a substantially cyclindrical surface region 560. In one embodiment, the distal end 565 of the cylinder 560 includes a substantially rectangular hollow region 570. In one aspect, the hollow region 570 may be formed by angled walls 575. In another embodiment, the distal end 565 of the cylinder 560 includes a substantially rectangular hollow region 570, not specifically shown.

In one arrangement, the rectangular hollow region 570 may extend the length of the portion 505. In another arrangement, the substantially rectangular or circular hollow region 570 may not extend the length of the portion 505.

The material used for forming the cup 102 may fill in the hollow region 570 and improve the anchoring strength between the cup 102 and the shaft part 230, in the embodiments where the cup 102 is over-molded or the embodiments where the cup 102 is not over-molded onto the shaft part 230.

FIG. 12C shows, in perspective view, a third examplary embodiment of the coupling feature 510. The coupling feature 510 includes a substantially cyclindrical region 580, a first notch 585 and a second notch 590 substantially parallel to the axis of the portion 505. The notches 585 and 590 may be symmetrically positioned in the third cylinder 580 leaving a central section 595 between the notches 585, 590. The central section 595 may also include a circular through-hole 600.

In one embodiment, a through-hole 600 may be disposed in the smallest diameter portion of one end of the shaft 230, and a cup 102 may be over-molded onto the end of the shaft 230 so that the material of the cup covers the hole 600. In one aspect, the material used in constructing the cup seeps through the hole and serves as an additional anchor that strengthens the attachment forces between the cup and the shaft. In another aspect, the material used for forming the cup 102 may fill in notched regions and the through hole 600 for improve the anchoring strength between the cup 102 and the shaft part 230, in the embodiments where the cup 102 is over-molded or the embodiments where the cup 102 is not over-molded onto the shaft part 230.

FIG. 12D shows, in a perspective view, a fourth examplary embodiment of the coupling feature 510 where the coupling feature 510 is “x”-shaped in horizontal cross-section A-A.

Again, the material used for forming the cup 102 may fill in recessed regions of the “X-shaped” to form a substantially cylindrical shaped for improving the anchoring strength between the cup 102 and the shaft part 230, in the embodiments where the cup 102 is over-molded or the embodiments where the cup 102 is not over-molded onto the shaft part 230.

FIG. 12E shows, in a perspective view, a fifth examplary embodiment of the coupling feature 510 where the coupling feature 510 is a structure 610 that is star-shaped in horizontal cross-section B-B.

As noted above in FIG. 12D, the material used for forming the cup 102 may fill in recessed regions of the star-shaped structure to form a substantially cylindrical shaped for improving the anchoring strength between the cup 102 and the shaft part 230, in the embodiments where the cup 102 is over-molded or the embodiments where the cup 102 is not over-molded onto the shaft part 230.

FIG. 12F shows, in a perspective view, a sixth examplary embodiment of the coupling feature 510 where the coupling feature 510 includes a substantially cylindrical region 615 substantially coaxial with the region 505. In one embodiment, the cylindrical region 615 includes a substantially rectangular through-hole 620 positioned diametrically in the cylindrical region 615. In another embodiment, the cylindrical region 615 includes a substantially circular through-hole 620 positioned diametrically in the cylindrical region 615, as exemplified in FIG. 12I.

The material used for forming the cup 102 may fill in the substantially rectangular or substantially circular through-hole 620 to improve the anchoring strength between the cup 102 and the shaft part 230, in the embodiments where the cup 102 is over-molded or the embodiments where the cup 102 is not over-molded onto the shaft part 230.

FIG. 12G shows, in perspective view, a seventh examplary embodiment of the coupling feature 510 where the coupling feature 510 is a structure 625 that is ellipse-shaped in horizontal cross-section C-C. The structure 625 has a first cut-out 630 and a second cut-out 635 at either end of the semi major axis 640 of the ellipse. The first cut-out 630 and second cut-out 635 extend from a distal end 645 of the structure 625 and stop at point before the region 505 thereby forming an essentially elliptically-shaped base 650 with a parallelpiped upper portion 655.

The structure 625 presents more bonding surfaces for the material used for forming the cup to improve the anchoring strength between the cup 102 and the shaft part 230, in the embodiments where the cup 102 is over-molded or the embodiments where the cup 102 is not over-molded onto the shaft part 230.

FIG. 12H shows, in perspective view, an eighth examplary embodiment of the coupling feature 510 where the coupling feature 510 is a parallelepiped 660. In other embodiments, the coupling feature 510 may be a square, a rectangular, or a hexagonal (as exemplified in FIG. 12K) shaped structure 660. These structures present more bonding surfaces for the material used for forming the cup to improve the anchoring strength between the cup 102 and the shaft part 230, in the embodiments where the cup 102 is over-molded or the embodiments where the cup 102 is not over-molded onto the shaft part 230.

FIG. 12I shows, as mentioned above, in perspective view, a ninth examplary embodiment of the coupling feature 510 where the coupling feature 510 is a fifth cylinder 665 positioned on the region 505 so that the fifth cylinder 665 is substantially coaxial with the region 505. The coupling feature 510 includes a diametric circular-shaped through-hole 670, as also mentioned above.

FIG. 12J, shows, in perspective view, a tenth examplary embodiment of the coupling feature 510 where the coupling feature 510 has a base portion 675 coupled to the portion 505 and a cap 680 coupled to the base portion 675. The base portion 675 may be a substantially parallelpiped-shaped. The base portion 675 includes a through-hole 670 perpendicular to the axis of the portion 505. The cap 680 is arcuate and concave in the direction toward the portion 505. The distal end 685 of the base portion 675 is curved to match the curvature of the cap 680. The cap 680 has a first end 690 and a second end 695 hanging over the sides 700 and 705 of the base portion.

In another embodiment, the cap 680 may also be coupled to cylindrical portion 665 exemplified in FIG. 12J.

In still other embodiments, as noted above, the through-hole 670 may be a square, or rectangular shape.

In yet still other embodiments, the cap 680 may be flat instead of curve as shown.

As mentioned above, these structures present more bonding surfaces for the material used for forming the cup to improve the anchoring strength between the cup 102 and the shaft part 230, in the embodiments where the cup 102 is over-molded or the embodiments where the cup 102 is not over-molded onto the shaft part 230.

FIG. 12K shows, in perspective view, as mentioned above, an eleventh examplary embodiment of the coupling feature 510 where the coupling feature 510 is a structure 710 that is hexagonally-shaped in horizontal cross-section D-D.

FIG. 12L shows, in perspective view, a twelfth examplary embodiment of the coupling feature 510 where the coupling feature 510 is a structure 715 that is generally cylindrically-shaped with two circumferential grooves 720 in the outer surface 725. The examplary embodiment in FIG. 12L shows two grooves, however alternative embodiments could have as few as one groove or more than two grooves. The grooves 720 divide the fifth structure 715 into three sections, a first section 730 coupled to the portion 505, a second (or middle) section 735 and a third (or distal) section 740. As shown, each section 730, 735, 740 is shaped somewhat differently from the others in horizontal cross-section. In alterative embodiments, each section 730, 735, 740 may a substantially similar shape. In further alternative embodiments, the grooves 720 may vary in depth.

In other embodiments, the exemplary structure in FIG. 12L may also have through-holes, as shown in FIGS. 12B, F or J. All these structures present more bonding surfaces for the material used for forming the cup to improve the anchoring strength between the cup 102 and the shaft part 230, in the embodiments where the cup 102 is over-molded or the embodiments where the cup 102 is not over-molded onto the shaft part 230, as also discussed above.

The term “over-molding” as used herein refers to the molding of the cup 102 around or onto a pre-formed shaft part. In some embodiments, during molding of the cup 102, parts of the shaft apart in contact with the material forming the cup may become softened or slightly melted, causing a co-mingling of the materials to form a stronger bond. In other embodiments, there is no softening or melting of the shaft part 230, and the cup material merely forms about the formations 510 and/or seeps into the holes in the formations 510. In still other embodiments, both the co-mingling and forming about the formations may happen.

In one embodiment of the invention, a reinforcing material may be placed through the through-holes, such as 575, 620 and 670 exemplified in FIGS. 12B, 12F, 12I and 12J. This reinforcing material may serve to strengthen the polymeric material used in the construction of the cup 102, and further improve the ability of the prophy cup to remain attached to the driven shaft during loading of the cup with polishing paste and polishing of teeth. In various embodiments, the reinforcing material may include organic fibers such as, for example, polyaramid (Kevlar (R)) fibers and inorganic fibers such as, for example, glass or carbon fibers. In another embodiment, the reinforcing material may include a solid member of a polymer material, a metallic material, or other shear-resistant material. In still another embodiment, the reinforcing material may include a miniature multi-stranded cable formed, for example, of stainless steel and/or titanium. In still another embodiment, the lateral reinforcing material may include a linked member, such as a chain of polymer links, metallic links, or links of other appropriate material.

The various formations discussed above are merely exemplaries of the coupling features and equivalent structures are also contemplated. These features themselves can improve the anchoring of the cup 102 to the driven shaft part 230 so as to counteract the tendency of the cup 102 to become detached from the prophy angle, either during rotation or during loading of polishing paste. Without wishing to be bound to a theory, it is surmised that the over-molding of the cup 102 onto the driven shaft part 230 may further improve the attachment of the cup 102 by further increasing the surface areas of contact of the cup 102 to the driven shaft part 230.

The prohy angle 100 may be made of any polymeric material, metal or metallic alloy. Examples of polymeric materials can include polyethylene, polypropylene, polybutylene, polystyrene, polyester, acrylic polymers, polyvinylchloride, polyamide, polycarbonate, polyetherimide like ULTEM® or the like; polymeric alloys such as Xenoy® resin, which is a composite of polycarbonate and polybutyleneterephthalate or Lexan® plastic, which is a copolymer of polycarbonate and isophthalate terephthalate resorcinol resin (all available from GE Plastics) are also suitable; liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198), polyesterimide anhydrides with terminal anhydride group or lateral anhydrides (exemplified in U.S. Pat. No. 6,730,377, the content of which is incorporated herein by reference)or combinations thereof; or biocompatible or biodegradable polymers including polyester material such as polylactic acid resin (comprising L-lactic acid and D-lactic acid); polyhydroxyvalerate/hydroxybutyrate resin (copolymer of 3-hydroxybutyric acid and 3-hydroxypentanoic acid (3-hydroxyvaleric acid) (PHBV) and polyhydroxyalkanoate (PHA) copolymers; polyester/urethane resin; other biocompatiable polymers such as Polysulfone, PPS (polyphenylene sulfide), PEEK (polyetheretherketone) or the like are also suitable. Also, in addition, any polymeric composites such as engineering prepregs or composites, which are polymers filled with pigments, carbon particles, silica, conductive particles such as metal particles or conductive polymers, or mixtures thereof can also be used.

Examples of suitable metal or metallic alloys can include stainless steel; an alloy such as Ni/Ti alloy; any amorphous metals including those available from Liquid Metal, Inc. or similar ones, such as those described in U.S. Pat. No. 6,682,611, and U.S. Patent Application No. 2004/0121283, the entire contents of which are incorporated herein by reference.

The gears may also be made of and not limited to acetal, such as Celcon M90, a copolymer (available from Ticona,Florence, Ketucky), Delrin® (available from Dupont, Wilmington, or the like; PPS (polyphenylene sulfide); or PEEK (polyetheretherketone); or the like.

The cup 102 may be made of any elastomeric material, including but is not limited to, polyurethane, polybutylene, latex rubber, or other rubber materials that can be either natural or synthetic rubber. Examples of synthetic rubbers that are elastomeric include various copolymers or block copolymers (i.e., Kratons®) available from Kraton Polymers, such as styrene-butadiene rubber (Buna rubber - copolymer of butadiene and styrene) or styrene isoprene, EDPM (ethylene propylene diene monomer) rubber, nitrile (acrylonitrile butadience) rubber, polysiloxanes (Silicone RTV), fluoropolymer (VitonR, available from DuPont Dow Elastomers), polychloroprene (Neoprene , available from DuPont), Santoprene (available from Monsanto Company), fluorosilicone rubber and the like. In addition, biocompatible or biodegradable materials mentioned above may also be used.

In some embodiments, materials used for the cup 102 may have a a melting temperature slightly higher than the softening temperature or melting temperature of the material for the shaft part 230 so that during molding of the cup 102 onto the shaft, part of the shaft may be softened or slightly melted, and the materials become co-mingled, leading to a better bonding of the cup 102 to the shaft. In these embodiments, even without the coupling features 510, the bond between the cup 102 and the shaft part 230 can minimize the detachment of the cup 102 during use.

In some embodiments, materials used for the cup 102 may have a high coefficient of elasticity, or small amount of compression during use. The amount of compression may be, for example, less than about 5%, more for example, less than about 3%. This can also facilitate the polishing action as well as the retention fo the polishing paste during use.

Any of the prophy angle 100 discussed above may be disposable. The use of disposable dental angles reduces the labor, cost, and risks of sterilization. To be cost effective, the manufacturing process is also amenable to mass production. The parts forming the prophy angle 100, cup 100 and gears 232 and 236 of the present invention may be mass produced in any conventional parts factory. However, the prophy angle 100 is rather compact in size, and in fact, the smaller the size that can still effectively carry out the polishing function and fit into a conventional handpiece, the more desirable is the angle 100. To assemble such an angle in a cost effective manner can be a challenge.

Typically, an exemplary assembly process may be carried in the following described manner (also summarized and exemplified in the schematic flow chart of FIG. 13):

The body of the prophy angle 100 may be molded as a two-piece housing 206 including a major portion having a skirt region 228, a neck region 210, and a partial head region 208, and a minor portion including a cap 258. The cap 258 includes the balance of the head region 208, as viewed in the assembled product 108 in FIG. 1. According to one aspect of the invention, the body region 212 may include a bore 212a that is substantially coaxial with a longitudinal axis of the skirt 228 and neck 210 regions. The bore 212a opens to a first aperture at a proximal end of the skirt region 228 and to a second aperture at a distal end of the neck region 210, so as to yield access to the head region 208. Both the head region 256 and 258 of the housing portions 206 and 213b, include a concave internal surface, such that when the major and minor housing portions 256 and 258 are assembled the concave internal surfaces define a cavity within the region.

According to one embodiment of the invention, the major 256 and minor 258 portions may be produced by for example, injection molding of a thermoplastic polymer. A driving shaft 216 may also be produced by injection molding of thermoplastic polymer, as is a driven shaft 230. During assembly of the prophy angle 100, the major portion of the housing 206 may be manually grasped, or placed in a fixturing device for manual or automatic assembly. The driving shaft 216 may be prepared by applying a lubricant to bearing surfaces thereof (and to a grease reservoir, in one embodiment of the invention). Thereafter, the driving shaft 216 may be inserted into the axial bore 212a within the housing 206 by placing the proximal end of the driving shaft 216 into the aperture of the axial bore 212a at the head end 208 of the housing 206 and urging the shaft 216 towards the distal end of the housing 206. During this process, according to one embodiment of the invention, it may be necessary to flex the driving shaft 216 so as to allow the driving gear 232 formed on the distal end of the driving shaft 216 to clear the edge of the housing 206 and enter the concave area within the head portion 208 of the housing 206. After the driving shaft 216 is positioned such that the gear 232 on the driving shaft 216 is in its operative position (typically indicated by a positive stop), the driven shaft 230, including the driven gear 236 may be installed into the half journal bearing within the major portion of the head 256.

According to one embodiment of the invention, a lubricant may be desirable on the driving 232 and driven 236 gears. In such a case, the driving 232 and driven 236 gears may be pre-greased, prior to installation, or lubrication may be added to the gears 232, 236 once the two shafts 216 and 230 are in position.

After the two shafts 216 and 230 are properly placed, the minor portion 258 (cap) of the housing 206 and 213b may be placed over the open region at the head 208 of the major portion of the housing 256. Thereafter, the assembly may be placed into an ultrasonic welding system, and the adjoining surfaces between the major and minor portions of the housing are fused together.

According to one embodiment of the invention, contacting edges of the major and minor housing portions may be substantially flat so as to form an even and matching surface for body between the two surfaces. In other embodiment of the invention, the contacting surfaces may include complimentary formations or features adapted to increase the surface area in common on the edges between the major and minor portions 256, 258, of the housing 206. These formations or features may include edges that include a snap-fit feature such as a groove and projection, where a projection on one portion fits into a groove of the other portion, or an overlapping portion, such as a skirt that can be laterally bonded to an underlying surface of the complementary portion to form, for example, an ultrasonic weld.

According to one embodiment of the invention, a radial closure shaped like a washer may be disposed coaxially on the driven shaft 230 between the driven gear 236 and the prophy cup 102. Also according to one embodiment of the invention, this radial closure may be bonded to the head portion 208 of the housing 206 during the ultrasonic welding process.

In one embodiment of the invention, a flexible prophy cup 102 may be added to a distal end of the driven shaft 230 after assembly of the driving 216 and driven 230 shafts within the housing 208 and the ultrasonic welding of the housing 208. In another embodiment of the invention, the prophy cup 102 may be added to the driven shaft 230 in an ancillary process prior to assembly of the prophy angle 100.

In one embodiment of the invention, a premolded prophy cup 102 may be fixedly coupled to a premolded driven shaft 230 using a bonding process such as thermal welding, ultrasonic welding, chemical welding or the application of a topical adhesive, as mentioned above. The pre-molded cup may be molded by injection molding.

In another embodiment of the invention, the prophy cup 102 may be molded in situ on a distal end of a pre-molded driven shaft 230. The molding may be carried by in situ solvent polymerization of a material, in situ particulate sintering of a material or isostatic compression molding.

In still another embodiment of the invention, the driven shaft may be molded or over-molded in place within a pre-molded prophy cup 102, as also discussed above.

According to one embodiment of the invention, a distal end of the driven shaft 230 may include a coupling feature 510 for the prophy cup 102. In various embodiments, the coupling feature 510 may be integrally molded onto the driven shaft 230, or may be affixed to the driven shaft 230 by welding, thermal bonding, adhesive bonding, threaded insertion, use of one or more mechanical fasteners or any other appropriate method. The coupling feature 510 may be desirably configured to prevent removal of the prophy cup from the driven shaft subsequent to assembly, as noted above in FIGS. 12A-L, by the inclusion of various formation discussed above in FIGS. 12A-L, or striation, convolutions or lateral extensions of its surface as serve to increase a surface area available for adhesion and otherwise anchor the prophy cup 102 to the coupling feature 510.

In one embodiment of the invention, the driven shaft 230 including the coupling feature 510 may be disposed within a mold or an injection molding die. An uncured polymer material, or a melted thermoplastic material may be introduced into a cavity within the die such that the polymer materials surrounds the coupling features 510. In some embodiments, the polymeric material also extends outside the circumferential span of the driven shaft part 230 in an over-molding mode as noted above.

As also noted above, some polymeric material for the construction of the cup 102 may have a melting temperature slightly higher than the softening temperature or melting temperature of the material for the shaft part 230 so that during molding of the cup 102 onto the shaft, part of the shaft may be softened or slightly melted, and the materials become co-mingled, leading to a better bonding of the cup 102 to the shaft.

In one embodiment of the invention, a reinforcing material may be placed through the through-holes, such as 575, 620 and 670 exemplified in FIGS. 12B, 12F, 12I and 12J, as mentioned above, prior to molding.

1. A prophy angle comprising:
a first axial bore having a proximal end and a distal end;
a second axial bore having a proximal end and a distal end, in communication with the first axial bore through the respective proximal ends;
a driving gear disposed inside the first axial bore including a gear part and a shaft part, the gear part including a substantially vertical surface having depression formed thereon; and
a driven gear disposed inside the second axial bore including a gear part and a shaft part, the gear part comprises a substantially horizontal surface having projections formed thereon;
wherein said depressions mate operatively with the projections.

2. The prophy angle of claim 1 further comprising a prophy cup attached to the shaft part of the driven gear.

3. The prophy angle of claim 1 further comprising a prophy cup molded onto the shaft part of the driven gear.

4. The prophy angle of claim 3 wherein said prophy cup is over-molded and has a larger circumferential span than the shaft part it is molded onto.

5. The prophy angle of claim 1 wherein the driving and driven gear comprises a crown and lantern gear.

6. The prophy angle of claim 1 wherein said projections of the driven gear comprises pin-like or bullet-shaped projections.

7. The prophy angle of claim 5 wherein said crown gear comprises a plurality of gear teeth, each tooth of said plurality of gear teeth comprising a pin region having a substantially cylindrical circumferential surface and a substantially hemispherical end surface, and a fillet region, said fillet region being disposed between said respective pin region and a central shaft of said crown gear.

8. The prophy angle of claim 2 wherein said prophy cup comprises a circumferential inner wall, said inner wall comprises retention features comprising axial straitions, radial striations or combinations thereof.

9. The prophy angle of claim 2 wherein said prophy cup comprises a circumferential inner wall defining a recess opening, said inner wall comprises retention features comprising a plurality of turbine-like vanes; a plurality of cross-ribs placed radially in the recessed opening; a plurality of bristles extending substantially vertically from a bottom of the recessed opening; a plurality of posts extending substantially vertically from a bottom of the recessed opening; a plurality of concentric circles concentric with the circumferential inner wall and set in a bottom of the recessed opening; or a plurality of arcs concentric to the circumferential inner wall set in a staggered pattern in a bottom of the recessed opening.

10. The prophy angle of claim 3 wherein said shaft part comprises formations adapted for improving the attachment between the cup and the shaft part.

11. The prophy angle of claim 10 wherein said formations comprises a through-hole; a star-shaped formation; a cross formation; a square; a rectangle; a hexagon; a concentric square; a slot; or combinations thereof.

12. The prophy angle of claim 10 wherein said formation comprises a vertical through-hole; a horizontal through-hole; a combination of a horizontal and a vertical through-hole through the side and the top of the shaft part; or a combination of horizontal and vertical through holes through the side and the length of the shaft part.

13. A drive shaft for a prophy angle, comprising:
a gear;
a first shaft region having a substantially circular cross-section of a first substantially uniform diameter and a first longitudinal axis;
a second shaft region having a substantially circular cross-section of a second substantially uniform diameter and a second longitudinal axis colinear with the first longitudinal axis, and a circumferential grease bearing surface, said second substantially uniform diameter being larger than said first substantially uniform diameter; and
a first and a second substantially circular collars, each said integral collar having a third diameter larger than said substantially uniform second shaft diameter; wherein said first shaft being disposed adjacent to said first substantially circular collar, said second shaft region being disposed between first and second substantially circular integral collars, and said gear being disposed at one end of said drive shaft.

14. The drive shaft of claim 13 wherein said second shaft region has a length along said longitudinal axis that substantially exceeds said second substantially uniform diameter.

15. The drive shaft of claim 13 wherein said drive shaft is part of a handpiece.

16. The drive shaft of claim 13 further comprising:
a disk coupled to said shaft, said disk having a substantially circular perimeter and an upper surface;
a plurality of pins having a respective plurality of longitudinal axes, each pin of said plurality of pins being disposed substantially perpendicular to said upper surface and adjacent to said perimeter; and
a plurality of fillets, each said fillet being disposed between said shaft and said plurality of pins respectively.

17. A prophy angle transmission element comprising:
a shaft having a longitudinal axis;
a disk coupled to said shaft, said disk having a substantially circular perimeter and an upper surface;
a plurality of pins having a respective plurality of longitudinal axes, each pin of said plurality of pins being disposed substantially perpendicular to said upper surface and adjacent to said perimeter; and
a plurality of fillets, each said fillet being disposed between said shaft and said plurality of pins respectively.

18. The prophy angle transmission element of claim 17 wherein each said pin comprises a substantially cylindrical outer surface disposed about said respective longitudinal axis; a substantially hemispherical top surface; a substantially ellipsoidal top surface; a substantially conical top surface; or a substantially truncated conical top surface.

19. The prophy angle transmission element of claim 17 wherein each said fillet of said plurality of fillets comprises a substantially rectangular member.

20. A prophy angle, comprising:
a prophy angle cup comprising a substantially cylindrical body member having a circumferential span, a distal end and proximal end, said cup comprises a recessed upper surface at the distal end thereof;
a driven shaft part having a circumferential span, comprising a formation adapted to be covered by said proximal end of said cup;
wherein said cup has a substantially larger circumferential span than that of the driven shaft part attached to the proximal end of the cup.

21. The prophy angle of claim 20 wherein said formation comprises a through-hole; a star-shaped formation; a cross formation; a square; a rectangle; a hexagon; a concentric square; a slot; or combinations thereof.

22. The prophy angle of claim 21 wherein said formation comprises a vertical through-hole; a horizontal through-hole; a combination of a horizontal and a vertical through-hole through the side and the top of the shaft part; or a combination of horizontal and vertical through holes through the side and the length of the shaft part.

23. The prophy angle of claim 20 wherein said formation further comprises a reinforcing member therein.

24. The prophy angle of claim 23 wherein said reinforcing member comprises an organic polymer fiber material or an inorganic fiber material.

25. The prophy angle of claim 20 said prophy cup comprises a circumferential inner wall, said inner wall comprises retention features comprising axial straitions, radial striations or combinations thereof.

26. The prophy angle of claim 20 wherein said prophy cup comprises a circumferential inner wall defining a recess opening, said inner wall comprises retention features comprising a plurality of turbine-like vanes; a plurality of cross-ribs placed radially in the recessed opening; a plurality of bristles extending substantially vertically from a bottom of the recessed opening; a plurality of posts extending substantially vertically from a bottom of the recessed opening; a plurality of concentric circles concentric with the circumferential inner wall and set in a bottom of the recessed opening; or a plurality of arcs concentric to the circumferential inner wall set in a staggered pattern in a bottom of the recessed opening.

27. The prophy angle of claim 26 wherein said is over-molded onto the driven shaft part.
